(19) United States
(12) Patent Application Publication
(10) Pub. No.: US 2011/0293907 A1
(43) Pub. Date: Dec. 1, 2011

(54) LASER PARAMETER ADJUSTMENT

(76) Inventor: Faycal Benayad-Cherif, Lexington, MA (US)

(21) Appl. No.: 13/147,608

(22) PCT Filed: Feb. 12, 2010
(86) PCT No.: PCT/US10/24006

§ 371 Date: Aug. 3, 2011

Related U.S. Application Data
(60) Provisional application No. 61/152,400, filed on Feb. 13, 2009.

(51) Int. Cl. B32B 3/10; B32B 15/00; B32B 27/00; B23K 26/00

(52) U.S. Cl. 428/209; 219/121.72; 428/195.1

(57) ABSTRACT

A method is provided for removing a substrate from a component with a laser. The method includes the steps of: applying a laser to a component at different locations with different power or different laser speed levels so as to remove a portion of a substrate from the component and thereby yield a number of markings on the component; measuring the different markings and generating a collection of data associated with different power or speed levels for the laser based on the markings; and adjusting at least one operating parameter of the laser based on the collection of data from the markings. Optionally, the method may be automated.

### CROSS REFERENCE TO RELATED APPLICATIONS

This application claim priority to U.S. Provisional Application No. 61/152,400 filed Feb. 13, 2009, and incorporated herein by reference in its entirety.

### BACKGROUND

It is known to use a laser to remove paint or lacquer in a manufacturing process. For instance, this process is used in the production of component parts which are illuminated from the back. In particular, an image may be created on a product of manufacture, such as a button. In such a process, a portion of the product being manufactured is removed using a laser as a removal tool. This portion of the product being removed is shaped so that it forms an image. A light can then be shown through the product, and the image formed through the laser removal is readily visible.

The product may then be installed as part of a larger device such as a handheld, vehicular or other electronic device. For instance light installed in a dashboard with a series of one or more buttons or other indicators in front of the light would shine through different images on the buttons, thereby providing a visual indicator as to the function of the button. This allows a user to distinguish different buttons, even in an otherwise dark environment. Alternatively, one or more of these buttons may be installed on an electronic device such as a computer or telephone, or any other device where it might be desirable to light a visual image.

In producing these component parts, such as buttons, it is desirable to ensure that the images are manufactured within predefined tolerances regarding the position, orientation and scale of the image.

It is also known to use similar laser based processes in engraving and other arts where it is necessary to remove a defined portion of a substrate.

### BRIEF SUMMARY OF THE INVENTION

The present disclosure provides a method of calibrating a laser for removing a substrate from a component with a laser.

In one embodiment, a method for removing a substrate from a component with a laser. The method includes providing a component including a substrate. The component is subjected to a laser at a plurality of different locations with a plurality of different power levels or different laser speed levels to remove a portion of the substrate from the component and thereby yield a number of markings on the component. The characteristics of the plurality of different markings are measured, thereby generating a collection of data associated with different power or speed levels for the laser. A relationship is created to represent the characteristics of the laser over different power or speed levels. At least one operating parameter of the laser is adjusted based on the curve representing the characteristics of the laser.

### BRIEF DESCRIPTION OF THE DRAWINGS

FIG. 1 is a graph showing the scale of a particular graphic as a function of power.

FIG. 2 shows exemplary products marked using different laser settings so to create test objects used to generate data representative of a laser's substrate removal characteristics

### DETAILED DESCRIPTION OF THE INVENTION

The present disclosure provides a method of calibrating a laser for removing a substrate from a component with a laser.

In certain embodiments, the invention relates to a technique that allows an operator to ensure that the dimensions of the area from which substrate material is removed with the laser falls within desired parameters or tolerances. For instance, where the technology is applied to a product including an image on a button, certain aspects of the inventive technique may be used to ensure the image has the desired scale. This can be achieved with a relatively high degree of precision. From a manufacturing perspective, a laser used for etching will degrade over time, though not necessarily at a constant rate. Aside from laser degradation, other variables that may have an affect on the overall effective laser power, as measured by the amount of substrate effectively removed with the laser, include environmental temperature and humidity.

In manufacturing a number of component parts using a laser removal process, it may be important to ensure that the same amount of material is removed from the part, or that the image created through removal of material has a uniform scale when compared against other parts.

Current customers are now finding out that the majority of their rejects are due to a scale change caused by a variation in paint thickness. Since the laser removal rate is constant, the thicker the paint, the less paint is removed and the smaller are the marked images or icons. In certain instances, where lacquer or paint is being removed from a component part, differences in the thickness of the lacquer or paint may result in differences in the image, such as an icon that is rendered on the component part. By ensuring that the laser power is appropriately adjusted, the manufacturing process can reliably create parts having icons of the same scale, or at least having a scale that falls within predefined tolerances.

In addition to the laser power, the speed at which the laser moves can be adjusted as the speed at which the laser moves affects the scale of the image being produced. If the laser moves too quickly, too little substrate material (paint or otherwise) is removed. If the laser moves too slowly, the laser may actually burn substrate. At an appropriate laser speed, the scale of the graphics will often vary in size with the laser power, so that laser power is often the most useful variable to adjust.

To determine the appropriate laser power, in one embodiment, a component part is marked by a laser at different locations with different power and/or speed levels. The characteristics of the marking may then be measured to create data associated with the different power and speed levels of the laser. This data may then be used to create a relationship representing the characteristics of the laser over different power and/or speed levels. The relationship may be expressed in the form of a curve, and equation, or a look-up table, for example.

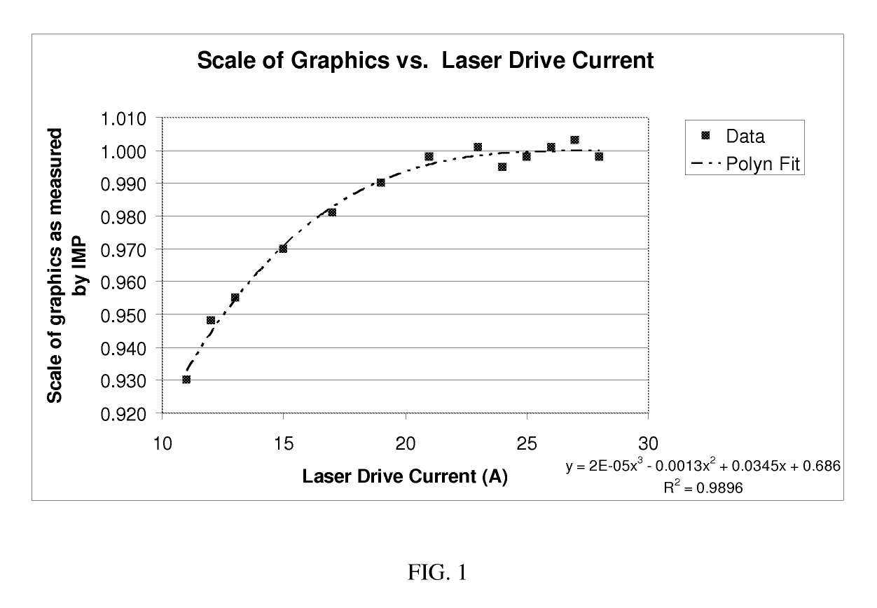

FIG. 1 shows the direct relationship between the scale of a particular graphic (a square shape) and laser power (expressed as current) for a particular manufacturing process, as the square data points. A similar curve (not shown) can be expressed to show the effect of speed on the scale. The behavior in both cases is similar, each one bearing a relationship to the removal rate.

This information is useful in a number of different ways:

1. Assuming constant substrate (such as paint, lacquer, or even metal material such as an alloy) characteristics have not changed, the curves can be used to predict paint thickness. With this information, a user can decide on what laser and speed parameters are appropriate.

2. Independently of substrate thickness or characteristics, the curve provides information on the laser parameters required to achieve the proper scaling. If the primary or only concern is the size (scale) of the icon or other graphic that is being produced, the user does not necessarily need to know the paint thickness.

Any or all of the steps in the process of marking a component with a laser at different locations with different power and/or speed levels, then measuring the characteristics of the different markings and thereby generating a collection of data associated with different power and/or speed levels for the laser and then creating a curve representing the characteristics of the laser over different power and/or speed levels, may be automated.

The square data points, representing the scale of a particular graphic (a square) and laser power for a particular manufacturing process can be used to generate a best fit curve (shown as a dashed line). A polynomial representing the best fit curve can then be determined. This polynomial can then be used to estimate the laser power. In the exemplary instance, this polynomial was determined to be:

y=2E−05x³−0.0013x²+0.0345x+0.686

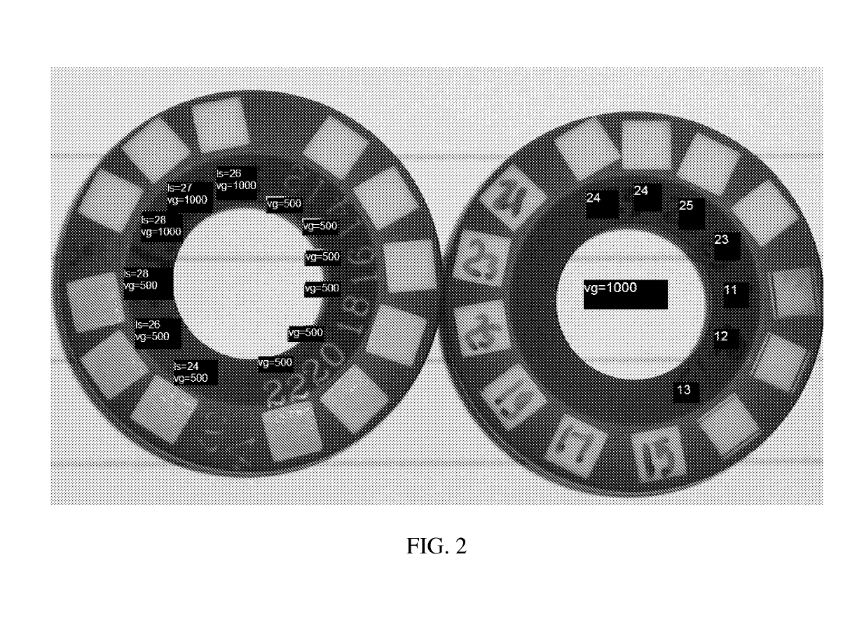

FIG. 2 shows exemplary products marked using different laser power settings to create test objects that may then be measured to generate data representative of the laser's substrate removal characteristics. The power settings were determined by current and ranged from 11 to 28 amps. In FIG. 2, the image being created by the laser is a square; accordingly, a series of squares are shown on each of the components.

In FIG. 2, the wheel on the right shows how the size of the graphics changes with laser power. Although not easily visible to the naked eye, each of the white squares has a different size. This process can yield highly repeatable results; indeed, when automated, size measurements were determined to a resolution of 0.01% and a repeatability of 0.2%.

The inventive techniques and products produced using these techniques allow a repeatable manufacturing process where the size of graphics may be maintained near constant. In preferred embodiments, the size of the graphics may be kept to within a scale of 100 μm, representing a variation of only 1% on a part that is only 10 mm in size. Larger or smaller size graphics similarly benefit. A measurement resolution of 1% represents the ability to measure variations of the order of 10 μm in size, close to 10 times tolerances necessary to avoid visually perceptible differences.

The development of a feedback measurement system based on laser power/scale or even laser power/thickness provides a new and useful improvement over previously known manufacturing process. The results of power/scale measurements have also shown a clear correlation and significant resolution thereby facilitating the inventive feedback system to adapt the laser power to the paint thickness variation, when desired.

Using the inventive techniques, a manufacturer will be able to:

Automatically adapt the laser parameter to the paint characteristics and thickness.

Repeat this process within the same batch several times on different parts to compensate for paint variations within the same batch and within the part placement in the painting booth.

Eliminate the need to have quality control heavily involved.

Allow manufacturers to achieve a higher yield.

Reduce waste.

Maximize production yield while maintaining correct graphic size.

The inventive method could open application to a wide variety of production technologies involving substrate removal via laser. For instance, the etching of metal, such as metal alloys is commonly performed using a laser as an etching tool. Like a paint or lacquer etching process, where the laser power is too weak, too little substrate material is removed. In contrast, where laser power is too high, too much substrate material may be removed and the remaining substrate material may be burned or scorched. Where there is a need to achieve a high level of precision and accuracy in these production processes, the present technique can be of tremendous benefit.

In an ongoing manufacturing process, the inventive method can be employed on a regular or routine basis so as to ensure the appropriate power and/or speed levels are selected for operation of the laser. Indeed, where the system is automated, for instance, where it is implemented by a computerized system, the method can automatically compensate for, for instance, a drop in laser power resulting from degradation in the laser based on recurrent use. This system can be used in combination with the Intelligent Mark Positioning techniques, which are useful to ensure proper and appropriate mark alignment, both in terms of position and orientation.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for removing a substrate from a component with a laser, the method comprising:
providing a component comprising a substrate;
subjecting the component to a laser at a plurality of different locations with a plurality of different power levels or different laser speed levels to remove a portion of the substrate from the component and thereby yield a number of markings on the component;
measuring characteristics of the plurality of different markings and thereby generating a collection of data associated with different power or speed levels for the laser;
creating a relationship representing the characteristics of the laser over different power or speed levels; and
adjusting at least one operating parameter of the laser based on the curve representing the characteristics of the laser.

2. The method of claim 1, wherein the at least one operating parameter is either laser power or laser speed.

3. The method of claim 2, wherein the at least one operating parameter is laser power.

4. The method of claim 2, wherein the at least one operating parameter is laser speed.

5. The method of claim 1, wherein the scale of the portion removed is less than or equal to 100 micron.

6. The method of claim 1 wherein the relationship is expressed as a curve.

7. The method of claim 1 wherein the relationship is expressed as an equation.

8. The method of claim 1 wherein the relationship is expressed as a look-up table.

9. The method of claim 1, wherein the component is subjected to the laser with a plurality of different power levels.

10. The method of claim 1, wherein the component is subjected to the laser with a plurality of different speed levels.

11. The method of claim 1 wherein the steps are automated.

12. A product produced by the method of claim 1.

13. The product of claim 12 wherein the product comprises an image adapted to be illuminated.

14. The product of claim 13 wherein the product is a button.

15. The product of claim 12 wherein the product comprises a plastic.

16. The product of claim 12 wherein the product comprises a metal.
